(19) United States
(12) Patent Application Publication
(10) Pub. No.: US 2024/0286637 A1
(43) Pub. Date: Aug. 29, 2024

(54) METHOD FOR OPERATING A VEHICLE

(71) Applicant: Robert Bosch GmbH, Stuttgart (DE)

(72) Inventor: Stephan Rhode, Karlsruhe (DE)

(21) Appl. No.: 18/398,808

(22) Filed: Dec. 28, 2023

(30) Foreign Application Priority Data
Feb. 28, 2023 (DE) 10 2023 201 818.7

(51) Int. Cl. B60W 60/00; B60W 50/00

(52) U.S. Cl. CPC B60W 60/001; B60W 50/0097; B60W 2050/0028; B60W 2520/14

(57) ABSTRACT

A method for operating a vehicle using a vehicle dynamics model. The method includes: providing input values of one or at least one of a plurality of input variables of the vehicle dynamics model; determining output values of one or at least one of a plurality of state variables of the vehicle dynamics model based on the input values, wherein the vehicle dynamics model includes a physical model component and a data-based model component, and providing the output values for use in the operation of the vehicle.

### CROSS REFERENCE

The present application claims the benefit under 35 U.S.C. § 119 of German Patent Application No. DE 10 2023 201 818.7 filed on Feb. 28, 2023, which is expressly incorporated herein by reference in its entirety.

### FIELD

The present invention relates to a method for operating a vehicle using a vehicle dynamics model as well as a computing unit and a computer program for carrying out the method.

### BACKGROUND INFORMATION

Vehicle dynamics models are a factor in particular in the field of driver assistance systems, but increasingly and generally also in the field of autonomous or automated driving of vehicles, in particular passenger cars or even trucks.

A vehicle dynamics model is a model of a vehicle or a part of the vehicle that can be used to illustrate or map dynamic situations of vehicle operation, so that a value of a variable input variable can be ascertained from a value of an output variable. An example of this would be ascertaining a resulting value or progression of a yaw rate for a specific value or progression of a steering angle speed. This makes it possible to predict the behavior of the vehicle at least for a certain period of time.

### SUMMARY

According to the present invention, a method for operating a vehicle as well as a computing unit and a computer program for carrying out the method are provided. Advantageous embodiments are the present invention are disclosed herein.

The present invention relates to the operation of a vehicle using a vehicle dynamics model, and in particular the vehicle dynamics model itself. According to an example embodiment of the present invention, generally speaking, input values for one or more input variables can be provided for the vehicle dynamics model, e.g., as measured values of a sensor, in particular also as a temporal progression. Output values for one or more state variables are then determined by means of the vehicle dynamics model based on the input values and can then be made available, e.g., for further use within a control system. In this sense, the vehicle dynamics model can thus likewise be used within a control system.

Conventional vehicle dynamics models are based on physical equations and can be constructed with varying degrees of complexity. Vehicle dynamics models are used in controllers of lane keeping assist systems or evasion assist systems, for example. Examples of vehicle dynamics models include the so-called single track model and the so-called roll model for vehicle dynamics. The so-called linear single track model, for example, is a very simple or even the simplest model for explaining the steady-state and non-steady-state lateral dynamics of two-track vehicles.

Such vehicle dynamics models can be adapted to data by optimizing the model parameters. If the optimization of the model parameters does not yet provide the desired accuracy, it is possible to switch from a low model complexity (e.g. a linear single track model) to a next higher complexity (e.g. a single track model with a non-linear tire characteristic curve). However, this switch in the model complexity is cumbersome. It requires a new implementation and the model parameters have to be optimized again. These conventional physical models are also referred to as white box models or gray box models, or can be assigned to the respective group.

Vehicle dynamics models based on so-called black box models are possible as well. These vehicle dynamics models are obtained purely based on data and, for example, include or are based on artificial neural networks or Gaussian processes. Reference will therefore also be made in the following to data-based vehicle dynamics models. The complexity of these vehicle dynamics models can be changed very easily, for example via the number of neurons in the neural networks or the number of kernel functions in “sparse” Gaussian processes. Optimizing the vehicle dynamics models on reference data is an integral part of modeling. However, the typically large memory requirements and the usually inaccurate extrapolation of this model class are a major disadvantage. The effort required to generate data is greater here than it is for the parameter optimization of the physical vehicle dynamics models.

So-called hybrid vehicle dynamics models can thus be placed between these two classes and vehicle dynamics models. These vehicle dynamics models represent a mixed form of physically inspired differential equations (i.e., a physical vehicle dynamics model) and neural or other data-based differential equations (i.e., a data-based vehicle dynamics model). The (overall) vehicle dynamics model thus comprises a physical model component and a data-based model component. Physical components that are based on energy conservation or pure kinematics, for example, and do not include any adjustable parameters, can be defined as ordinary differential equations (ODE). The neural network (or generally the data-based model component) no longer has to model these components, but is instead applied to components the physics of which are unknown or which have adjustable parameters. This results in a vehicle dynamics model that combines the advantages of physical vehicle dynamics models and data-based (or data-driven) vehicle dynamics models. Compared to black box models, the hybrid vehicle dynamics model typically has a lower memory requirement.

A single track model can in particular include or be based on the following variables as state variables (or states): a position in a first direction, e.g., an x-direction (relative to a spatially or Earth-fixed coordinate system, specifically a Cartesian coordinate system), a position in a second direction, e.g., a y-direction (relative to the spatially or Earth-fixed coordinate system), a yaw angle, a steering angle, a speed of the vehicle (effective, not in longitudinal direction), a sideslip angle and a yaw rate.

Possible input variables for the single track model (i.e. variables, the values of which can be taken into account as known values, e.g. measured values) are in particular an acceleration of the vehicle, in particular in longitudinal direction, and a steering angle speed.

The objective of such a single track model, and generally of all models, is to model the future trajectories of the states as accurately as possible using a given starting vector of the states and given temporal progressions for the input variables (e.g. measured values or other values).

As a physical vehicle dynamics model, the single track model can include or can be represented by several differential equations (i.e. a set of differential equations), in particular ordinary differential equations. For a more detailed description with the specific differential equations, reference is made here to the description of the figures.

This model includes a plurality of different parameters, such as a coefficient of friction with respect to the roadway, front and rear spacing of the respective vehicle axle to the center of gravity of the vehicle, front and rear cornering stiffness, height of the center of gravity above the roadway, the gravitational constant, the vehicle mass and the moment of inertia around the vertical axis in the center of gravity. Some of these parameters can, or should, be optimized vehicle parameters, e.g. the vehicle mass.

As a data-based vehicle dynamics model, the single track model can be expressed relatively simply. for example via a neural network. Here, too, there are differential equations. In this case, all derivatives of the states are modeled by the neural network. For a more detailed description with the specific differential equations, reference is made here to the description of the figures.

The proposed vehicle dynamics model according to an example embodiment of the present invention is now a hybrid vehicle dynamics model with a physical model component and a data-based model component. The vehicle dynamics model is in particular a single track model or is at least based on a single track model. It is therefore in particular a kind of mixture of the two aforementioned models. The vehicle dynamics model has good extrapolation via the physical component or model component and it can be adapted to data using the data-based component or model component, e.g. the neural network. It is more accurate than a purely physical vehicle dynamics model and has better extrapolation than the purely data-based vehicle dynamics model.

According to an example embodiment of the present invention, the respective method for operating a vehicle using this vehicle dynamics model then includes providing input values of one or at least one of a plurality of input variables of the vehicle dynamics model. These input values can be measured values, for example. Possible input variables are in particular one or more of the already mentioned input variables. Output values of one or at least one of a plurality of state variables of the vehicle dynamics model are then determined based on the input values. Possible state variables are in particular one or more of the already mentioned state variables. The output values are then provided for use in the operation of the vehicle. It should be noted here that it is not necessary to output output values for all state variables on which the vehicle dynamics model is based. This can vary, for example depending on the desired use.

In one example embodiment of the present invention, the physical model component includes one or more differential equations, specifically for one or more of the following state variables: the position in the first direction, the position in the second direction, the yaw angle, the steering angle, the speed of the vehicle and the yaw rate.

In one example embodiment of the present invention, the data-based model component includes or relates to one or more of the following state variables: the steering angle, the speed of the vehicle, the sideslip angle and the yaw rate. The input variables are in particular only taken into account in the data-based model component.

The proposed hybrid vehicle dynamics model according to the present invention can preferably be used in lane keeping assist systems, or in functions for autonomous or automated driving. Combination with a controller (e.g., a model predictive controller) results in a software function that can be delivered within a control device. The vehicle dynamics model combines the advantages of known purely physical or purely data-based models. The good adaptation to measurement data is provided by the data-based component, in particular the so-called neural differential equations. The model complexity can be controlled very easily by changing the number of neurons in the hidden layer of the neural network. The physical component, which is based purely on kinematics and does not contain any uncertainties, improves the accuracy of the extrapolation compared to the purely data-based model.

A computing unit according to the present invention, e.g. a control device of a motor vehicle, is configured, in particular in terms of programming, to carry out a method according to the present invention.

The implementation of a method according to the present invention in the form of a computer program or computer program product comprising program code for carrying out all method steps is advantageous as well, because the associated costs are very low, in particular if an executing control device is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g. via a WLAN, a 3G, 4G, 5G or 6G connection, etc.).

Further advantages and embodiments of the present invention will emerge from the description and the figures.

The present invention is illustrated schematically in the figures on the basis of an embodiment example and is described in the following with reference to the figures.

### BRIEF DESCRIPTION OF THE DRAWINGS

FIG. 1 schematically shows a vehicle, in which a method according to the present invention can be used.

FIG. 2 shows a schematic illustration to explain a vehicle dynamics model, according to an example embodiment of the present invention.

FIG. 3 schematically shows a sequence of a method according to the present invention in a preferred embodiment.

FIGS. 4A-4C show graphs comparing different vehicle dynamics models.

### DETAILED DESCRIPTION OF EXAMPLE EMBODIMENTS

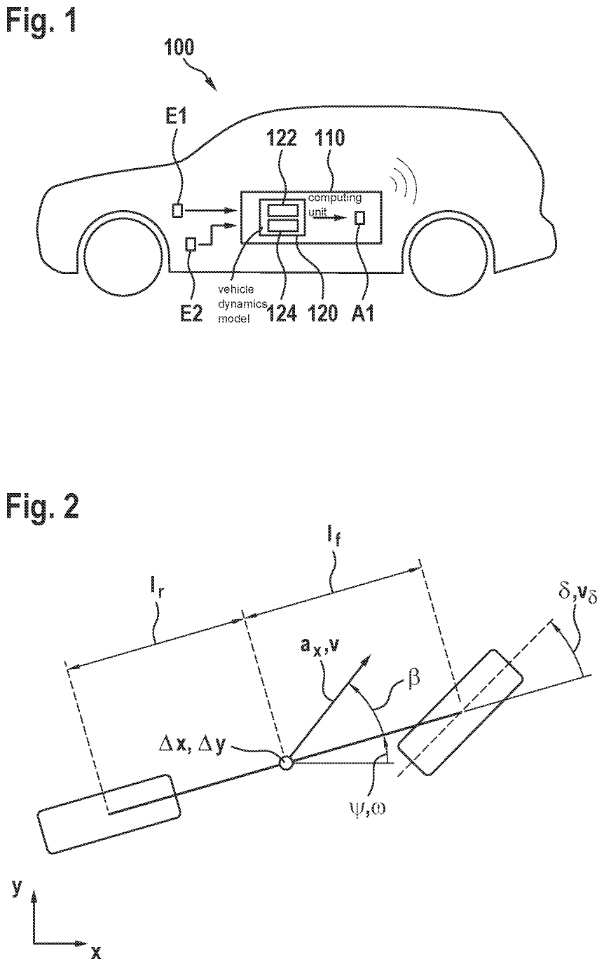

FIG. 1 schematically shows a vehicle 100, in which a method according to the present invention can be used. As an example, the vehicle 100 comprises a computing unit 110, which is configured as a control device and on which, for example, a driver assistance function with a control, e.g., a lane keeping assist function or an evasion assist function can be carried out. A vehicle dynamics model 120 that obtains input values of one or more input variables and based on these determines output values of one or more state variables can be used as part of such a driver assistance function. Two input values are labeled E1, E2, for example, and an output value is labeled A1, for instance.

The vehicle dynamics model 120 includes a physical model component 122 and a data-based model component 124, which is show here schematically and merely as an example. A more detailed explanation follows with reference to the following figures.

FIG. 2 shows a schematic illustration to explain a vehicle dynamics model, specifically for a so-called single track model. A single track model can in particular include or be based on the following variables as state variables (or states): a position Δx in a first direction, e.g. an x-direction (relative to a spatially or Earth-fixed coordinate system, specifically a Cartesian coordinate system), a position Δy in a second direction, e.g. a y-direction (relative to the spatially or Earth-fixed coordinate system), a yaw angle ψ, a steering angle δ, a speed v of the vehicle (effective, not in longitudinal direction), a sideslip angle β and a yaw rate ω. These variables can be represented as a vector (state variable vector) as follows:

$$x = {[ Δ x , Δ y , ψ , δ , v , β , ω ]}^{T}$$

Possible input variables for the single track model (i.e. variables, the values of which can be taken into account as known values, e.g. measured values) are in particular an acceleration aₓ of the vehicle, in particular in longitudinal direction (the time derivative of the speed v), and a steering angle speed vs (the time derivative of the steering angle δ). These variables can be represented as a vector (input variable vector) as follows:

$$u = {[ {a}_{x} , {v}_{δ} ]}^{T}$$

The objective of such a single track model, and generally of all models, is to model the future trajectories of the states as accurately as possible using a given starting vector of the states and given temporal progressions for the input variables (e.g. measured values or other values).

As a physical vehicle dynamics model, the single track model can include or can be represented by several differential equations (i.e. a set of differential equations), in particular ordinary differential equations. For the single track model, these can be the following differential equations, for example:

$$\frac{dx}{dt} = [ \begin{matrix}\begin{matrix}v cos ( ψ + β ) \\ v sin ( ψ + β ) \\ ω \\ {v}_{δ} \\ {a}_{x}\end{matrix} \\ ( ( \frac{μ}{{v}^{2} ( {l}_{r} + {l}_{f} )} ( {C}_{r} ( g {l}_{f} + {a}_{x} h ) {l}_{r} - {C}_{f} ( g {l}_{r} - {a}_{x} h ) {l}_{f} ) - 1 ) ω - \\ \frac{μ}{v ( {l}_{r} + {l}_{f}} ( {C}_{r} ( g {l}_{f} + {a}_{x} h ) + {C}_{f} ( g {l}_{r} - {a}_{x} h ) ) β + \frac{μ}{v ( {l}_{r} + {l}_{f} )} ( {C}_{f} ( g {l}_{r} - {a}_{x} h ) ) δ ) \\ ( - \frac{μ m}{{vI}_{z} ( {l}_{r} + {l}_{f} )} ( {l}_{f}^{2} {C}_{f} ( g {l}_{r} - {u}_{x} h ) + {l}_{r}^{2} {C}_{r} ( g {l}_{f} + {a}_{x} h ) ) ω + \\ \frac{μ m}{{I}_{z} ( {l}_{r} + {l}_{f} )} ( {l}_{r} {C}_{r} ( g {l}_{f} + {a}_{x} h ) - {l}_{f} {C}_{f} ( g {l}_{r} - {a}_{x} h ) ) β + \\ \text{} \frac{μ m}{{I}_{z} ( {l}_{r} + {l}_{f} )} {l}_{f} {C}_{f} ( g {l}_{r} - {a}_{x} h ) δ ) ,\end{matrix} ]$$

dx/dt on the left side is the time derivative of the starting vector of the states or the state vector x, and thus the time derivatives of the mentioned state variables. With the seven lines on the right, this results in seven differential equations.

This model includes a plurality of different parameters, such as a coefficient of friction μ with respect to the roadway, front l_{f} and rear spacing lₕ of the respective vehicle axle to the center of gravity of the vehicle, front C_{f} and rear Cᵣ cornering stiffness, height h of the center of gravity above the roadway, the gravitational constant g, the vehicle mass m and the moment of inertia I_{z} around the vertical axis in the center of gravity. Some of these parameters can, or should, optimized vehicle parameters, e.g. the vehicle mass m.

As a data-based vehicle dynamics model, the single track model can be expressed or represented relatively simply as follows, here using the example of a neural network:

$$\frac{d x}{d t} = NN ( 𝒵 \{ {[ x , u ]}^{T} \} , θ , t )$$

Here, too, there are differential equations, so-called neural differential equations. In this case, all derivatives of the states are modeled by the neural network NN. Again, x,u stands for the vectors as described above. θ refers to a weighting matrix of the neural network and t is the time or the time dependence. [symbol] {⋅} refers to a Z-score transformation. It can also be seen here that the neural network has nine inputs, namely the state variables and the actual input variables.

The proposed vehicle dynamics model is now a hybrid vehicle dynamics model with a physical model component and a data-based model component. The proposed vehicle dynamics model is in particular a single track model or is at least based on a single track model. It is therefore in particular a kind of mixture of the two aforementioned models. The vehicle dynamics model has good extrapolation via the physical component or model component and it can be adapted to data using the data-based component or model component, e.g. the neural network. It is more accurate than a purely physical vehicle dynamics model and has better extrapolation than the purely data-based vehicle dynamics model.

In one embodiment example, the physical model component includes differential equations for the following state variables: the position Δx in the first direction, the position Δy in the second direction, the yaw angle ψ, the steering angle δ, the speed v of the vehicle and the yaw rate ω. The data-based model component includes the following state variables, for example: the steering angle δ, the speed v of the vehicle, the sideslip angle β and the yaw rate ω. The input variables acceleration aₓ of the vehicle, in particular in longitudinal direction, and steering angle speed v_{δ} are in particular included only in the data-based model component. They are then not found in the differential equations of the physical model component.

The differential equations of the physical model component and the data-based model component can then in particular be represented as follows:

$$\frac{dx}{dt} = [ \begin{matrix}v cos ( ψ + β ) \\ v sin ( ψ + β ) \\ ω \\ {v}_{δ} \\ NN ( 𝒵 \{ {[ δ , v , β , ω , {u}_{x} , {v}_{δ} ]}^{T} \} , θ , t )\end{matrix} ]$$

The first four lines in the vector of the state variable derivatives, i.e. the first four differential equations, are identical to the linear single track model as a physical vehicle dynamics model here. These relationships are based purely on kinematics and do not include any unknown physical effects or unknown parameters. The fifth to seventh state variables or their derivatives, on the other hand, are represented via the data-based model component, i.e. modeled with so-called neural ordinary differential equations, for instance. They obtain the input variables and some state variables from the previous time step as input.

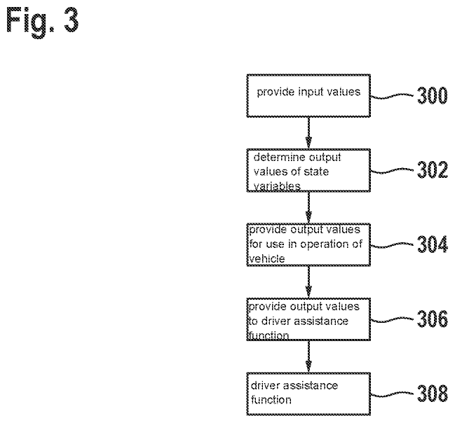

FIG. 3 schematically shows a sequence of a method according to the present invention in a preferred embodiment. For this purpose, in a Step 300, input values of one or at least one of a plurality of input variables of the vehicle dynamics model are provided. These can be measured values from sensors, for example. In a Step 302, output values of one or at least one of a plurality of state variables of the vehicle dynamics model are then determined based on the input values. As mentioned, the vehicle dynamics model comprises a physical model component and a data-based model component. In a Step 304, the output values are then provided for use in the operation of the vehicle. In a Step 306, the output values can, for instance, be provided to a driver assistance function 308 for control.

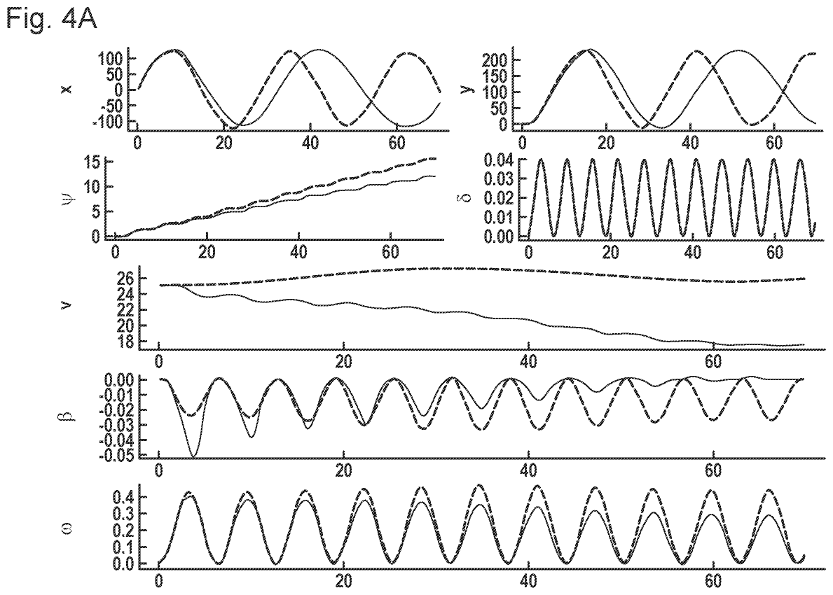

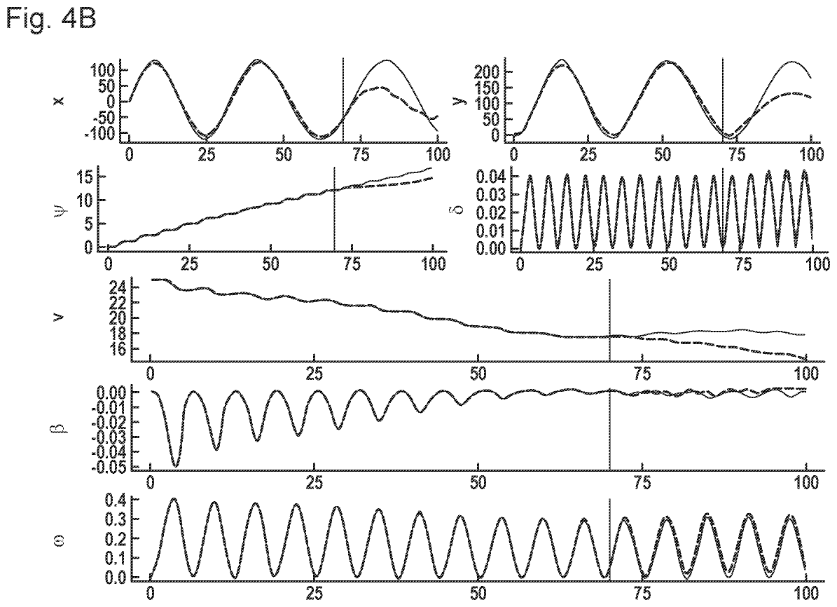

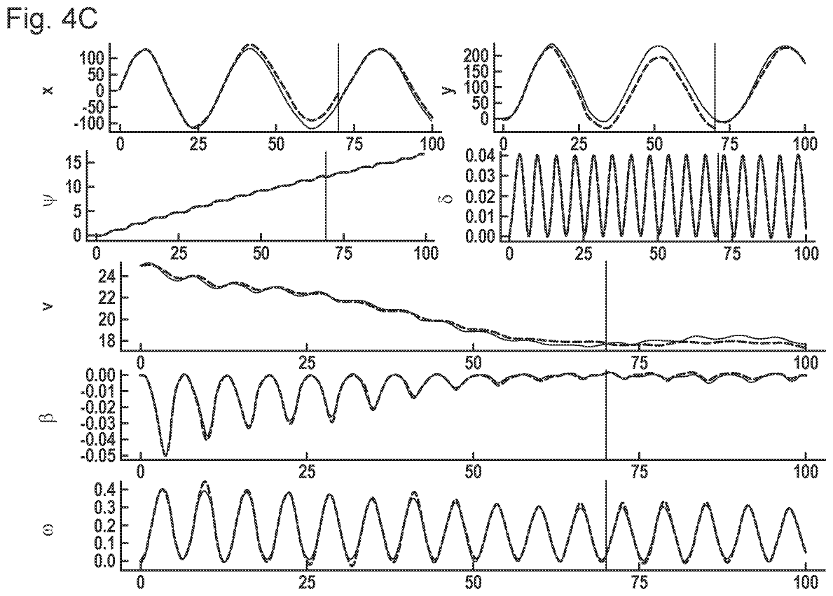

FIGS. 4A-4C show graphs comparing different vehicle dynamics models. Temporal progressions of the values are shown for the various state variables, position x in the first direction, position y in the second direction, yaw angle ψ, steering angle δ, speed v of the vehicle, sideslip angle β and yaw rate ω, specifically in each case over a time in seconds. The solid lines indicate reference values, i.e., real values, whereas the dashed lines indicate the values determined by means of the respective vehicle dynamics model. FIG. 4A shows the conventional physical single track model, FIG. 4B shows the purely data-based vehicle dynamics model and FIG. 4C shows the proposed hybrid vehicle dynamics model.

It can be seen that the physical vehicle dynamics model in FIG. 4A has poor accuracy, e.g. because the non-linear tire-roadway contact is not taken into account. The purely data-based vehicle dynamics model in FIG. 4B shows very high accuracy in the training range (to the left of 70 seconds), but drifts away from the reference data in the extrapolation range (between 70 and 100 seconds). Although somewhat less accurate in the training range, the hybrid vehicle dynamics model in FIG. 4C exhibits very accurate and stable extrapolation.

The physical model does not require any parameter estimation or training, because it is a so-called “first principles model” and shares the exact vehicle parameters with the reference model. Neural differential equations, on the other hand, can be used in the so-called hidden layer as part of training with different sizes to find the optimal model complexity. The hidden layer can be varied from five to 14 neurons in the neural differential equation model (ODE model), for example, and from five to 12 neurons in the general differential equation model (UDE model). Due to the smaller size of the input and output layer, the UDE model generally has fewer weights in the network weight matrix than the neural ODE model. The neural ODE model and the UDE model can be trained, for instance sequentially, on sets (here 0<t<70 s) of the reference data. A sum of the squared error cost function can be applied across all states. In this example, this cost function works with the mentioned Z-score transform to give each state (state variable) the same weight.

To train the data-based model component or the neural differential equations, the data should always be scaled before it enters a neural network (this can be accomplished by means of the Z-score transformation).

In the example shown in FIGS. 4A-4C, the data follow a sinusoidal path (because of the relationships in the differential equations, this in particular also applies in general); this can be seen very well for the positions x, y, but also for the yaw rate. For conventional training, an optimizer for the weights of the neural network would be presented with all of the training data at once. Because of the sinusoidal path, however, the optimizer quickly converges to a local optimum by approximately providing a straight horizontal line in the images. This can be explained by the sinusoidal shape. The reason is that a horizontal progression includes both positive and negative errors, which are then summed.

To avoid this and obtain the results shown here, the so-called multiple shooting method can be used. The training data (between 0 and 70 seconds here) are divided into equal portions. The optimizer therefore only sees one short section at a time, e.g. a half sine, which it can fit well. All partial optimizations can be coupled by side conditions at the edges such that no jumps are allowed.

What is claimed is:

1. A method for operating a vehicle using a vehicle dynamics model, comprising the following steps:
providing input values of one or at least one of a plurality of input variables of the vehicle dynamics model;
determining output values of one or at least one of a plurality of state variables of the vehicle dynamics model based on the input values, wherein the vehicle dynamics model includes a physical model component and a data-based model component; and
providing the output values for use in operation of the vehicle.

2. The method according to claim 1, wherein the one or more state variables include one or more of the following state variables:
a position in a first direction,
a position in a second direction, which is in perpendicular to the first direction,
a yaw angle,
a steering angle,
a speed of the vehicle,
a sideslip angle,
a yaw rate.

3. The method according to claim 2, wherein the physical model component includes one or more differential equations for one or more of the following state variables:
the position in the first direction,
the position in the second direction,
the yaw angle,
the steering angle,
the speed of the vehicle,
the yaw rate.

4. The method according to claim 2, wherein the data-based model component includes one or more of the following state variables:
the steering angle,
the speed of the vehicle,
the sideslip angle, and
the yaw rate.

5. The method according to claim 1, wherein the one or more input variables include one or more of the following variables:
an acceleration of the vehicle in longitudinal direction, and
a steering angle speed.

6. The method according to claim 5, wherein the one or more input variables are included only in the data-based model component.

7. The method according to claim 1, wherein the vehicle dynamics model is based on a single track model.

8. The method according to claim 1, wherein the data-based model component is based on one or more artificial neural networks and/or one or more Gaussian processes.

9. The method according to claim 1, wherein the one or at least one of the plurality of output variables is used for regulating a driver assistance function, wherein the driver assistance function includes: (i) a lane keeping assist function, or (ii) an evasion assist function, or (iii) a driver assistance function used in the context of automated or autonomous driving of the vehicle.

10. A computing unit configured to operate a vehicle using a vehicle dynamics model, the computing unit configured to:
provide input values of one or at least one of a plurality of input variables of the vehicle dynamics model;
determine output values of one or at least one of a plurality of state variables of the vehicle dynamics model based on the input values, wherein the vehicle dynamics model includes a physical model component and a data-based model component; and
provide the output values for use in operation of the vehicle.

11. A non-transitory machine-readable storage medium on which is stored a computer program for operating a vehicle using a vehicle dynamics model, the computer program, when executed by a computer, causing the computer to perform the following steps:
providing input values of one or at least one of a plurality of input variables of the vehicle dynamics model;
determining output values of one or at least one of a plurality of state variables of the vehicle dynamics model based on the input values, wherein the vehicle dynamics model includes a physical model component and a data-based model component; and
providing the output values for use in operation of the vehicle.
